(19) United States
(12) Patent Application Publication
(10) Pub. No.: US 2025/0268368 A1
(43) Pub. Date: Aug. 28, 2025

(54) EDS/UV Brush System for Dust Mitigation

(71) Applicant: Georgia Tech Research Corporation, Atlanta, GA (US)

(72) Inventors: Gabriel Rizzo, Atlanta, GA (US); Julie S. Linsey, Atlanta, GA (US); Zhen S. Liu, Atlanta, GA (US); Cherie Lum, Atlanta, GA (US); Aliya Mahmud, Atlanta, GA (US); Christina M. Paris, Atlanta, GA (US); Micah J. Schaible, Atlanta, GA (US); Kristoffer G. Sjolund, Atlanta, GA (US); Eleanor Smith, Atlanta, GA (US)

(21) Appl. No.: 18/705,014

(22) PCT Filed: Oct. 27, 2022
(86) PCT No.: PCT/US2022/078789

§ 371 Date: Apr. 26, 2024

Related U.S. Application Data
(60) Provisional application No. 63/272,464, filed on Oct. 27, 2021.

(51) Int. Cl. A46B 15/00

(52) U.S. Cl. CPC A46B 15/0034; A46B 15/002; A46B 2200/3073

(57) ABSTRACT

An exemplary embodiment of the present disclosure provides an electrodynamic dust shielding (EDS) system that can comprise a brush, an ultraviolet (UV) enclosure, and a control module. The brush can comprise a plurality of bristles and one or more electrodes interspersed among the plurality of bristles, and can be configured to operate in an EDS-enabled state and a non-EDS-enabled state. The UV enclosure can comprise a cavity that can be configured to receive the brush and a UV emitter that can be configured to radiate UV energy to the plurality of bristles. The control module can be configured to apply an electric potential to the one or more electrodes when the brush is in the EDS-enabled state.

### CROSS-REFERENCE TO RELATED APPLICATIONS

This application claims the benefit of U.S. Provisional Application Ser. No. 63/272,464, filed on 27 Oct. 2021, which is incorporated herein by reference in its entirety as if fully set forth below.

### GOVERNMENT LICENSING RIGHTS

This invention was made with government support under Agreement No. NNA17BF68A, awarded by the Solar System Exploration Research Virtual Institute under the National Aeronautics and Space Administration. The government has certain rights in the invention.

### FIELD OF THE DISCLOSURE

The various embodiments of the present disclosure relate generally to hybrid electrodynamic dust shielding (EDS) and ultraviolet (UV) systems and methods.

### BACKGROUND

Lunar dust poses an obstacle to sustained human and robotic operations on the moon's surface, especially as a health risk to the astronauts themselves. The dust from the lunar regolith layer is rough and adhesive. If present in the airlock or astronaut living quarters, fine lunar dust particles can be inhaled, which can cause toxic respiratory effects to the astronauts, and can interfere with functional capabilities of the astronauts' technology. Previous solutions for removing dust from spacesuits and other surfaces involved astronauts using a handheld brush to remove the lunar regolith dust. The issues presented with these handheld brush designs are that these designs are ergonomically difficult for an astronaut to use without fatigue or strain. Astronauts are faced with low tactile feedback due to the inflation of their gloves. compromised dexterity due to the bulk of their gloves, and limited mobility in the shoulder region. Additionally, the lunar dust essentially sticks to the brush with no adequate catalyst to remove it due to the electrostatic adhesion of the dust particles.

Thus, a need yest exists for a brush design that can be securely handled by the astronauts despite lack of tactile feedback, causes minimal strain and fatigue on the wrist, and works around limited mobility by utilizing the availability of a helping partner or extendable agent of the brush design. Furthermore, a need also exists for a dust removal process from the brush itself that does not proliferate or cause further contamination in a low gravity, no atmosphere environment.

### BRIEF SUMMARY

An exemplary embodiment of the present disclosure provides an electrodynamic dust shielding (EDS) system that can comprise a brush, an ultraviolet (UV) enclosure, and a control module. The brush can comprise a plurality of bristles, one or more electrodes interspersed among the plurality of bristles, and can be configured to operate in an EDS-enabled state and a non-EDS-enabled state. The UV enclosure can comprise a cavity that can be configured to receive the brush and a UV emitter that can be configured to radiate UV energy to the plurality of bristles. The control module can be configured to apply an electric potential to the one or more electrodes when the brush is in the EDS-enabled state.

In any of the embodiments disclosed herein, the brush can further comprise a base plate wherein the plurality of bristles can comprise a first end coupled to the base plate and a second end extending away from the base plate. The brush can further comprise a mount coupled to the base plate.

In any of the embodiments disclosed herein, the brush can further comprise a UV emitter configured to radiate UV energy to the plurality of bristles when the brush is in the EDS-enabled state. The UV emitter can comprise one or more UV fiberoptics coupled to the base plate that can be configured to radiate UV energy to the plurality of bristles when the brush is in the EDS-enabled state.

In any of the embodiments disclosed herein, the one or more electrodes and the plurality of bristles can be in an alternating row arrangement.

In any of the embodiments disclosed herein, when the brush is in the EDS-enabled state, the control module can be configured to apply the electric potential to the one or more electrodes such that adjacent rows of electrodes in the alternating row arrangement receive electric potential that differs in phase by 180 degrees.

In any of the embodiments disclosed herein, when the brush is in the EDS-enabled state, the control module can be configured to apply the electric potential to the one or more electrodes such that adjacent rows of electrodes in the alternating row arrangement receive electric potential that differs in phase by 120 degrees.

In any of the embodiments disclosed herein, the control module can be integrated into the brush. The control module can be located externally to the brush and can be further configured to connect to the brush via a physical wired interconnection. The control module can be configured to apply an alternating current (AC) electric potential to the one or more electrodes when the brush is in the EDS-enabled state.

In any of the embodiments disclosed herein, the electric potential can be configured to attract dust particles to the plurality of bristles, The electric potential can be configured to repel dust particles from the plurality of bristles.

In any of the embodiments disclosed herein, the control module can further comprise a module enclosure configured to house the control module. The control module can comprise an actuator configured to toggle the brush between the EDS-enabled state and the non-EDS-enabled state. The actuator can be disposed on the module enclosure. The actuator can be a toggle switch. The toggle switch can be configured to bias between a first position to place the brush in the EDS-enabled state and a second position to place the brush in the non-EDS-enabled state.

In any of the embodiments disclosed herein, the UV enclosure can comprise an actuator that can be configured to activate the UV emitter. The UV emitter can be further configured to radiate UV energy to the plurality of bristles to remove at least a portion of dust particles from the plurality of bristles.

Another embodiment of the present disclosure provides a method of removing dust. The method can comprise: providing a brush comprising a plurality of bristles, a base plate, and one or more electrodes interspersed among the bristles; brushing, with the brush, a surface comprising dust particles, such that at least a portion of the dust particles are attracted to the plurality of bristles; placing the brush in an EDS-enabled state such that electric potential is applied to the one or more electrodes; and applying ultraviolet (UV) energy to the plurality of bristles to remove the at least a portion of the dust particles that are attracted to the plurality of bristles from the plurality of bristles.

In any of the embodiments disclosed herein, the method can further comprise toggling an actuator to place the brush into the EDS-enabled state.

In any of the embodiments disclosed herein, the method can further comprise providing UV energy to the brush from a UV emitter comprising one or more UV fiberoptics coupled to the base plate and configured to radiate UV energy to the plurality of bristles when the brush is in the EDS-enabled state to remove the at least a portion of the dust particles that are attracted to the plurality of bristles from the plurality of bristles.

In any of the embodiments disclosed herein, the method can further comprise placing the brush into a UV enclosure. The UV enclosure can comprise a cavity that can be configured to receive the brush and a UV emitter that can be configured to apply UV energy to the plurality of bristles to remove the at least a portion of the dust particles that are attracted to the plurality of bristles from the plurality of bristles. The method can further comprise toggling an actuator to activate the UV emitter.

In any of the embodiments disclosed herein, the method can further comprise the one or more electrodes and the plurality of bristles being arranged in an alternating row arrangement. The method can further comprise applying the electric potential, when the brush is in the EDS-enabled state, by a control module to the one or more electrodes such that adjacent rows of electrodes in the alternating row arrangement receive electric potential that differs in phase by 180 degrees. The method can further comprise applying the electric potential, when the brush is in the EDS-enabled state, by the control module to the one or more electrodes such that adjacent rows of electrodes in the alternating row arrangement receive electric potential that differs in phase by 120 degrees.

In any of the embodiments disclosed herein, the method can further comprise applying an alternating current (AC) electric potential to the one or more electrodes when the brush is in the EDS-enabled state. The method can further comprise applying the electric potential, when the brush is in the EDS-enabled state, to attract dust particles to the plurality of bristles. The method can further comprise applying the electric potential, when the brush is in the EDS-enabled state, to repel dust particles from the plurality of bristles

These and other aspects of the present disclosure are described in the Detailed Description below and the accompanying drawings. Other aspects and features of embodiments will become apparent to those of ordinary skill in the art upon reviewing the following description of specific, exemplary embodiments in concert with the drawings. While features of the present disclosure may be discussed relative to certain embodiments and figures, all embodiments of the present disclosure can include one or more of the features discussed herein. Further, while one or more embodiments may be discussed as having certain advantageous features, one or more of such features may also be used with the various embodiments discussed herein. In similar fashion, while exemplary embodiments may be discussed below as device, system, or method embodiments, it is to be understood that such exemplary embodiments can be implemented in various devices, systems, and methods of the present disclosure.

### BRIEF DESCRIPTION OF THE DRAWINGS

The following detailed description of specific embodiments of the disclosure will be better understood when read in conjunction with the appended drawings. For the purpose of illustrating the disclosure, specific embodiments are shown in the drawings. It should be understood, however, that the disclosure is not limited to the precise arrangements and instrumentalities of the embodiments shown in the drawings.

FIG. 1 shows a computer aided design (CAD) illustration of an exemplary EDS and UV enabled brush. The illustration shows features of the brush such as the plurality of bristles, one or more electrodes, mount, base plate and UV emitter in accordance with an exemplary embodiment of the present disclosure.

FIG. 2 shows a computer aided design (CAD) illustration of an exemplary UV enclosure. The illustration shows features of the brush such as a cavity and an UV emitter, in accordance with an exemplary embodiment of the present disclosure.

FIG. 3 shows a computer aided design (CAD) illustration of an exemplary control module. The illustration shows features of the control module such as a control module enclosure and an actuator in accordance with an exemplary embodiment of the present disclosure.

FIG. 4 shows a method flow chat for using an exemplary EDS and UV brush system for removing dust in accordance with exemplary embodiments of the present disclosure.

### DETAILED DESCRIPTION

To facilitate an understanding of the principles and features of the present disclosure, various illustrative embodiments are explained below. The components, steps, and materials described hereinafter as making up various elements of the embodiments disclosed herein are intended to be illustrative and not restrictive. Many suitable components, steps, and materials that would perform the same or similar functions as the components, steps, and materials described herein are intended to be embraced within the scope of the disclosure. Such other components, steps, and materials not described herein can include, but are not limited to, similar components or steps that are developed after development of the embodiments disclosed herein.

It must also be noted that, as used in the specification and the appended claims, the singular forms “a,” “an” and “the” include plural references unless the context clearly dictates otherwise. For example, reference to a component is intended also to include composition of a plurality of components. References to a composition containing “a” constituent is intended to include other constituents in addition to the one named.

Also, in describing the exemplary embodiments, terminology will be resorted to for the sake of clarity. It is intended that each term contemplates its broadest meaning as understood by those skilled in the art and includes all technical equivalents which operate in a similar manner to accomplish a similar purpose.

By “comprising” or “containing” or “including” is meant that at least the named compound, element, particle, or method step is present in the composition or article or method, but does not exclude the presence of other compounds, materials, particles, method steps, even if other such compounds, material, particles, method steps have the same function as what is named.

It is also to be understood that the mention of one or more method steps does not preclude the presence of additional method steps or intervening method steps between those steps expressly identified. Similarly, it is also to be understood that the mention of one or more components in a composition does not preclude the presence of additional components than those expressly identified.

The materials described as making up the various elements of the invention are intended to be illustrative and not restrictive. Many suitable materials that would perform the same or a similar function as the materials described herein are intended to be embraced within the scope of the invention. Such other materials not described herein can include, but are not limited to, for example, materials that are developed after the time of the development of the invention.

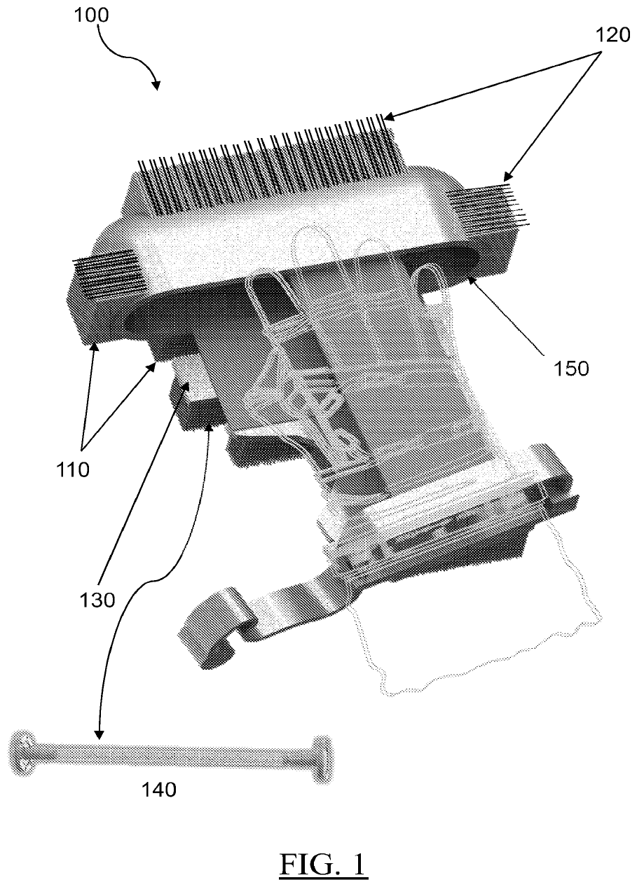

FIG. 1 is a CAD illustration of an exemplary embodiment of a brush 100 that can be utilized in a hybrid dust mitigation system. The brush 100 can include a plurality of bristles 110, one or more electrodes 120, a base plate 130, an UV emitter 140, and a mount 150. The brush 100 as shown in FIG. 1, within said hybrid dust mitigation system, can leverage both electrodynamic dust shielding (EDS) and ultraviolet (UV) technologies to remove at least a portion of dust particles attracted to the plurality of bristles 110. The brush 100 can have one or more electrodes 120 interspersed among the plurality of bristles 110 and can be configured to operate in an EDS-enabled state and a non-EDS-enabled state. The plurality of bristles 110 of the brush 100 can include a first end, which can be coupled to the base plate 130, and a second end, which can extend away from the base plate 130. In an example embodiment, as shown in FIG. 1, the brush can be divided into three segments attached to a mount 150 that move independently when in use. The design of the brush 100 can be advantageous in lunar environments with astronauts, for example, as it can be ergonomically efficient for astronauts in spacesuits by coupling to the astronaut's glove, which may make attempting to remove lunar dust from their spacesuits, technology and other surfaces impacting mission success. As can be appreciated, the mount 150 of the brush 100 can be repurposed and scaled in design for attachment to various apparatuses and is not so limited to the embodiment shown in FIG. 1.

As one skilled in the pertinent art will appreciate, the EDS technology utilized by the brush 100 when it is placed in the EDS-enabled state is based on EDS theory. EDS theory teaches that when a sufficiently strong electric field is provided, with distribution governed by Gauss's Law, particles can be transported away from a surface. The electric field created by one or more electrodes can produce non-uniform, time varying force distributions comprised of Coulomb and dielectrophoretic forces distributed to particles on the surface. The generated field can create free charge carriers that migrate to and accumulate on the surfaces of dust particles and then all the dust particles with charge are levitated by the Coulomb force and travel over the surface under the influence of the electric field. It should be appreciated that the influence of the electric field generated between the one or more electrodes, when applying a single or dual phase electric potential to the one or more electrodes, can produce a standing wave. It should also be appreciated that the influence of the electric field generated between the one or more electrodes, when applying a three-phase electric potential, can produce a traveling wave. As shown in FIG. 1, the brush 100 can include one or more electrodes 120 interspersed amongst the plurality of bristles 110. Therefore, through application of EDS theory an electric field created by the one or more electrodes 120 of the brush, when in the EDS-enabled state, can also produce non-uniform, time varying force distributions comprised of Coulomb and dielectrophoretic forces. Furthermore, the generated electric field can charge neutral dust particles that can in turn be levitated by the Coulomb force and attracted to the plurality of bristles 110, which can then be removed from the plurality of bristles 110 by the applied field generated by the one or more electrodes 120. In some embodiments the brush 100 may have a one, two, or three phase electric potential applied to the one or more electrodes 120 by the control module 300.

The brush 100 can also include a UV emitter 140 that can be configured to radiate UV energy to the plurality of bristles 110. In some exemplary embodiments, the UV emitter 140 can be one or more UV fiberoptics that can be coupled to the base plate 130 and can be configured to radiate UV energy to the plurality of bristles 110 when the brush 100 is in the EDS-enabled state. As one skilled in the pertinent art will appreciate, UV energy, when exposed to surfaces, can eject electrons which can leave said surfaces exposed to UV energy positively charged and the electrons can collect on nearby grain surfaces. The extra charge on the grain surfaces, due to UV energy exposure, can allow for movement of particles on the surface when a small electric potential is applied. With respect to the exemplary embodiment shown in FIG. 1, dust particles amongst the plurality of bristles 110, when exposed to the UV energy radiated by the UV emitter 140, can charge at least a portion of the dust particles from the plurality of bristles 110 of the brush 100. Given that the UV emitter 140 can radiate UV energy while the brush 100 is in the EDS-enabled state, the one or more electrodes 120 can also generate an electric field to the plurality of bristles 110 simultaneously. Resultantly, the generated electric field by the one or more electrodes 120 can provide the small electric potential to the charged dust particles, therein removing at least a portion of the dust particles from the plurality of bristles 110 of the brush 100. Through simultaneous activation of the UV emitter 140 and the generated electric field of the one or more electrodes 120, the brush 100 can achieve higher efficacy in the removal of dust particles from the plurality of bristles 110 through the combination of EDS and UV technologies.

As shown in FIG. 1, the one or more electrodes 120 and the plurality of bristles 110 can be arranged in an alternating row arrangement. In some embodiments, the arrangement of the plurality of bristles 110 and the one or more electrodes 120 of the brush 100 can manipulated in proportion to size or scale based on the application or physical environment where it can be implemented. When the brush 100 enters the EDS-enabled state, the one or more electrodes 120 can receive an electric potential signal from the control module 300. The control module 300 can be configured to apply an alternating current (AC) electric potential to the one or more electrodes 120 when the brush 100 is in the EDS-enabled state.

As discussed previously, the electric field generated by the one or more electrodes 120 when the brush 100 is in the EDS-enabled state can be a non-uniform, time varying force distributions that can include Coulomb and dielectrophoretic forces. The electric field generated by the one or more electrodes 120 can be attributed to the control module 300, which can apply an alternating current (AC) electric potential to the one or more electrodes 120 when the brush 100 is in the EDS-enabled state As one skilled in the pertinent art will appreciate, AC electric potential can be produced by switching the potential between two terminals in a fixed time interval, meaning AC electric potential can vary in magnitude and phase over time. Therefore, in some embodiments, the control module 300 can apply an AC potential to the one or more electrodes 120 such that adjacent rows of the one or more electrodes in the alternating row arrangement receive AC potential that differs in phase by 180 degrees. In other embodiments, when in the EDS-enabled state, the control module 300 can apply an AC potential to the one or more electrodes 120 such that adjacent rows of the one or more electrodes in the alternating row arrangement receive AC potential that differs in phase by 120 degrees.

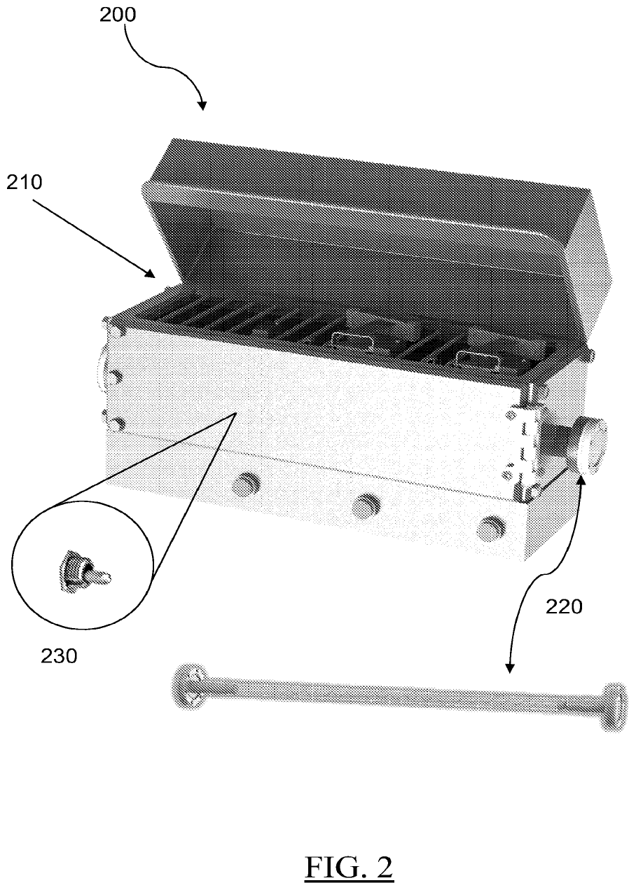

FIG. 2 illustrates a computer aided design (CAD) illustration of an exemplary UV enclosure. As one who is skilled in the pertinent art will appreciate, the effectiveness of UV energy charging and mitigating particles is dependent on a high-intensity UV source, which can create design tradeoffs between size and effectiveness of a UV source. In addition to the UV emitter 140 coupled to the base plate 130 of the brush 100, the UV enclosure 200 can allow for a larger UV source. As shown in FIG. 2, the UV enclosure 200 can include a cavity 210 that can be configured to receive the brush, an UV emitter 220 that can be configured to radiate UV energy to the plurality of bristles 110, and an actuator 230 that can be configured to activate the UV emitter.

As one skilled in the pertinent art will appreciate, an actuator can be many different device that cause a machine or device to perform an operation, including, but not limited to, switches, buttons, levers, and the like. In some embodiments, the brush 100 can be placed in the cavity 210 of the UV enclosure 200, when the brush 100 is in the EDS-enabled state. Once the actuator 230 is biased, the UV emitter can radiate UV energy to the plurality of bristles 110 to remove at least a portion of dust particles from the plurality of bristles 110. As discussed previously, simultaneous activation of the UV emitter 220 of the UV enclosure, the UV emitter 140 of the brush 100, and the generated electric field of the one or more electrodes 120, the brush 100 can achieve higher efficacy in the removal of dust particles from the plurality of bristles 110.

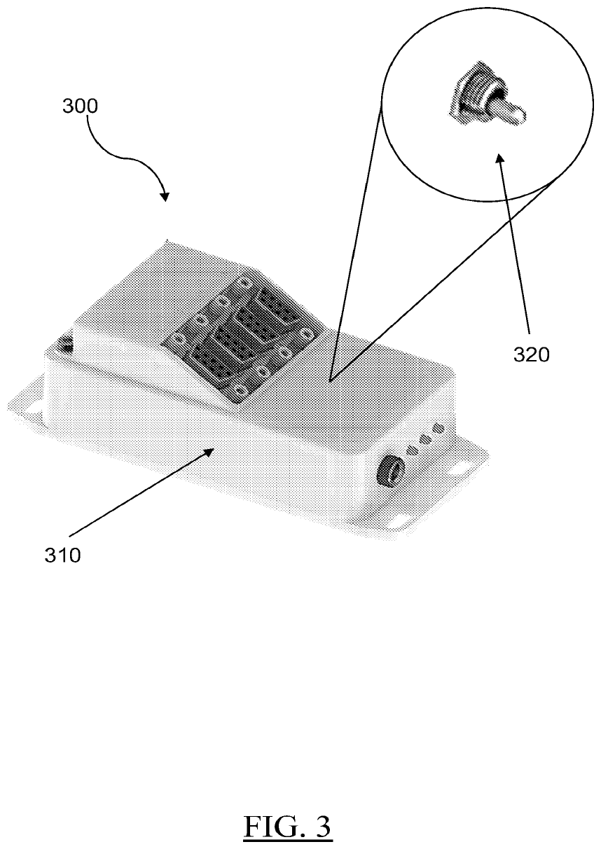

FIG. 3 illustrates a computer aided design (CAD) illustration of an exemplary control module 300. The control module 300 can include an actuator 320 that can be configured to toggle the brush 100 between the EDS-enabled state and the non-EDS-enabled state and a module enclosure 310 that can be configured to house the control module 300. In some embodiments, the actuator 320 for the control module 300 may be a toggle switch that can be disposed on the module enclosure 310. The toggle switch may be configured to bias between a first position, which can place the brush 100 in the EDS-enabled state, and a second position, which can place the brush 100 in the non-EDS-enabled state.

In some embodiments the control module 300 can be integrated into the brush 100. The control module 300 being integrated into the brush 100 can be advantageous as it can allow an astronaut to quickly toggle between the EDS-enabled state and non-EDS-enabled state while using the brush 100. In some embodiments, the control module can be located externally to the brush 100 and can be further configured to connect to the brush 100 via a physical wired connection. It should be appreciated that although a wire can be defined as metal in the form of a usually very flexible thread or slender rod, there can be various embodiments of wires that can form physical wired interconnections between two end systems. Examples of wires can include but not be limited to ribbon cables, shielded cables, data cables, coaxial cables, fiber optics cables, twisted pair cables, USB cables, SPI cables, ethernet cables, and the like.

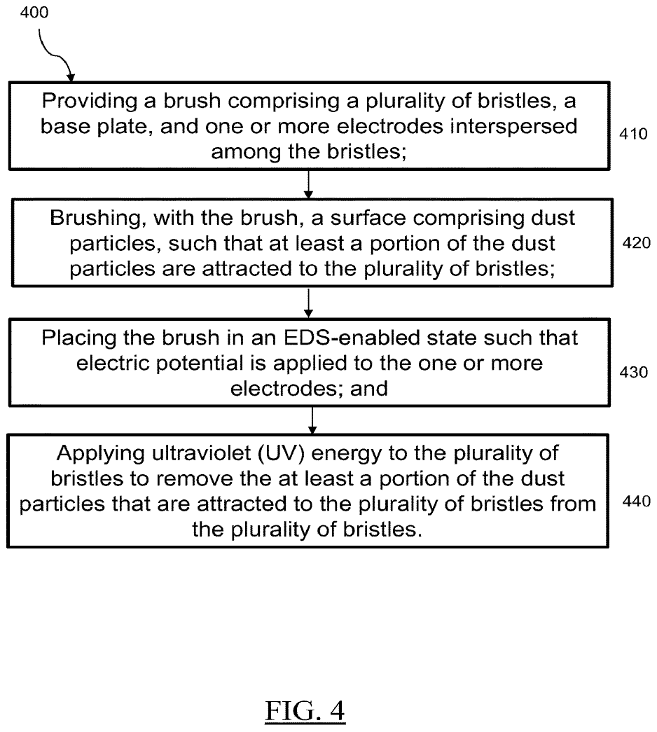

FIG. 4 illustrates a method flow chart 400 describing how to use the hybrid EDS and UV system to remove dust from a surface. The first step 410 can include providing a brush 100 that can include a plurality of bristles 110, a base plate 130, and one or more electrodes 120 interspersed among the bristles 110. The next step 420 can include brushing, with the brush 100, a surface comprising dust particles, such that at least a portion of the dust particles are attracted to the plurality of bristles 110. In some embodiments, an astronaut, using the mount 150 to attach the brush 100 to his spacesuit, may brush his spacesuit with the brush 100 in the non-EDS-enabled state upon noticing dust particles prior to entering through the airlock toward his living quarters to reduce contamination. In some embodiments, an astronaut, using the mount 150 to attach the brush 100 to his spacesuit, may also brush his spacesuit with the brush 100 in the EDS-enabled state, which may aid in increased dust removal from his spacesuit. The next step 430 can include placing the brush 100 in an EDS-enabled state such that electric potential is applied to the one or more electrodes 120. For example, the astronaut, upon finishing brushing his spacesuit, may activate the EDS-enabled state for the brush 100 which may apply an electrical potential to the one or more electrodes 120 of the brush 100. The final step 440 can include applying UV energy to the plurality of bristles 110 to remove the at least a portion of the dust particles that are attracted to the plurality of bristles 110 from the plurality of bristles 110. In some embodiments, the astronaut may have completed the brushing of the spacesuit and placed the brush 100 in the EDS-enabled state, which can include the simultaneous activation of the one or more electrodes 120 and the UV emitter 140 of the brush 100 to increase the efficacy of the dust removal from the brush 100.

It is to be understood that the embodiments and claims disclosed herein are not limited in their application to the details of construction and arrangement of the components set forth in the description and illustrated in the drawings. Rather, the description and the drawings provide examples of the embodiments envisioned. The embodiments and claims disclosed herein are further capable of other embodiments and of being practiced and carried out in various ways. Also, it is to be understood that the phraseology and terminology employed herein are for the purposes of description and should not be regarded as limiting the claims.

Accordingly, those skilled in the art will appreciate that the conception upon which the application and claims are based may be readily utilized as a basis for the design of other structures, methods, and systems for carrying out the several purposes of the embodiments and claims presented in this application. It is important, therefore, that the claims be regarded as including such equivalent constructions.

Furthermore, the purpose of the foregoing Abstract is to enable the United States Patent and Trademark Office and the public generally, and especially including the practitioners in the art who are not familiar with patent and legal terms or phraseology, to determine quickly from a cursory inspection the nature and essence of the technical disclosure of the application. The Abstract is neither intended to define the claims of the application, nor is it intended to be limiting to the scope of the claims in any way.

1. An electrodynamic dust shielding (EDS) system comprising:
a brush comprising:
bristles; and
one or more electrodes interspersed among the bristles;
wherein the brush is configured to operate in an EDS-enabled state and a non-EDS-enabled state; and
an ultraviolet (UV) enclosure comprising:
a cavity configured to receive the brush and a UV emitter configured to radiate UV energy to the bristles; and
a control module configured to apply an electric potential to one or more of the electrodes when the brush is in the EDS-enabled state.

2. The EDS system of claim 1, wherein the brush further comprises:
a base plate; and
wherein the bristles comprise a first end coupled to the base plate and a second end extending away from the base plate.

3. The EDS system of claim 2, wherein the brush further comprises;
a mount coupled to the base plate; and
a UV emitter configured to radiate UV energy to the bristles when the brush is in the EDS-enabled state

4. (canceled)

5. The EDS system of claim 3, wherein the UV emitter comprises:
one or more UV fiberoptics coupled to the base plate and configured to radiate UV energy to the bristles when the brush is in the EDS-enabled state.

6. The EDS system of claim 1, wherein the one or more electrodes and the bristles are in an alternating row arrangement; and
wherein, when the brush is in the EDS-enabled state, the control module is further configured to apply the electric potential to one or more of the electrodes such that adjacent rows of electrodes in the alternating row arrangement receive electric potential that differs in phase by 180 degrees.

7. (canceled)

8. The EDS system of claim 1, wherein the one or more electrodes and the bristles are in an alternating row arrangement; and
wherein, when the brush is in the EDS-enabled state, the control module is further configured to apply the electric potential to one or more of the electrodes such that adjacent rows of electrodes in the alternating row arrangement receive electric potential that differs in phase by 120 degrees.

9. The EDS system of claim 1, wherein the control module is:
integrated into the brush; or
located externally from the brush and is further configured to connect to the brush via a physical wired interconnection.

10. (canceled)

11. The EDS system of claim 9, wherein the control module is further configured to apply an alternating current (AC) electric potential to one or more of the electrodes when the brush is in the EDS-enabled state.

12. The EDS system of claim 1, wherein the electric potential is configured to:
attract dust particles to the bristles; or
repel dust particles from the bristles.

13. (canceled)

14. The EDS system of claim 1, wherein the control module comprises;
a module enclosure configured to house the control module; and
a first actuator configured to toggle the brush between the EDS-enabled state and the non-EDS-enabled state.

15. (canceled)

16. The EDS system of claim 14, wherein at least one of:
the first actuator is disposed on the module enclosure; or
the first actuator is a toggle switch configured to bias between a first position to place the brush in the EDS-enabled state and a second position to place the brush in the non-EDS-enabled state.

17.-18. (canceled)

19. The EDS system of claim 1, wherein the UV enclosure further comprises:
a second actuator configured to activate the UV emitter.

20. The EDS system of claim 19, wherein the UV emitter is further configured to radiate UV energy to the bristles to remove at least a portion of dust particles from the bristles.

21. A method of removing dust with the EDS system of claim 1 comprising:
brushing, with the brush, a surface with dust particles, such that at least a portion of the dust particles are attracted to the bristles;
placing the brush in the EDS-enabled state such that the electric potential is applied to one or more of the electrodes; and
applying ultraviolet (UV) energy to the bristles to remove at least a portion of the dust particles that are attracted to the bristles from the bristles.

22. The method of claim 21 further comprising;
toggling a first actuator to place the brush into the EDS-enabled state; and
providing the UV energy to the brush from a UV emitter;
wherein the UV emitter comprises one or more UV fiberoptics coupled to a base plate of the brush and configured to radiate the UV energy to the bristles when the brush is in the EDS-enabled state.

23. (canceled)

24. The method of claim 22 further comprising;
placing the brush into the UV enclosure comprising: a cavity configured to receive the brush; and
toggling a second actuator to activate the UV emitter.

25.-26. (canceled)

27. The method of claim 21 further comprising:
applying the electric potential when the brush is in the EDS-enabled state by the control module to one or more of the electrodes;
wherein the one or more electrodes and the bristles are arranged in an alternating row arrangement;
wherein applying the electric potential is such that adjacent rows of electrodes in the alternating row arrangement receive electric potential that differs in phase; and
wherein the phase is selected from the group consisting of by 180 degrees and by 120 degrees.

28. (canceled)

29. The method of claim 21 further comprising:
applying an alternating current (AC) electric potential to one or more of the electrodes when the brush is in the EDS-enabled state.

30. The method of claim 21 further comprising:
applying the electric potential when the brush is in the EDS-enabled state to attract dust particles to the bristles.

31. The method of claim 21 further comprising:
applying the electric potential when the brush is in the EDS-enabled state to repel dust particles from the bristles.
